(19) United States
(12) Patent Application Publication
(10) Pub. No.: US 2025/0031003 A1
(43) Pub. Date: Jan. 23, 2025

(54) SPATIALLY-BOUNDED AUDIO ELEMENTS WITH DERIVED INTERIOR REPRESENTATION

(71) Applicant: Telefonaktiebolaget LM Ericsson (publ), Stockholm (SE)

(72) Inventors: Tommy FALK, Spånga (SE); Werner DE BRUIJN, Stockholm (SE)

(73) Assignee: Telefonaktiebolaget LM Ericsson (publ), Stockholm (SE)

(21) Appl. No.: 18/286,736

(22) PCT Filed: Apr. 14, 2022
(86) PCT No.: PCT/EP2022/089973

§ 371 Date: Oct. 12, 2023

(51) Int. Cl. H04S 7/00

(52) U.S. Cl. CPC H04S 7/304; H04S 2400/01; H04S 2400/11; H04S 2400/15; H04S 2420/11

(57) ABSTRACT

A method for rendering an audio element is provided. The method comprises obtaining an exterior representation of the audio element. The method further comprises based on the obtained exterior representation, generating an interior representation of the audio element.

### TECHNICAL FIELD

This disclosure relates to derived interior representation of spatially-bounded audio elements.

### BACKGROUND

Spatial audio rendering is a process used for presenting audio within extended reality (XR) (e.g., virtual reality (VR), augmented reality (AR), or mixed reality (MR)) environment in order to give the listener the impression that the audio is coming from physical audio sources at certain position(s) and/or from physical audio sources that have a particular extent (e.g., the size and/or shape of the audio sources). The audio presentation can be made through speakers (e.g., headphones, tabletop speakers). In this disclosure, “sound” and “audio” are used interchangeably.

If the audio presentation is made via headphones, the process for presenting the audio is called a binaural rendering. The binaural rendering uses spatial cues of the human spatial hearing, enabling the listener to hear the audio from the direction sounds are coming from. These cues involve Inter-aural Time Difference (ITD), Inter-aural Level Difference (ILD), and/or spectral difference.

The most common form of spatial audio rendering is based on the concept of point-sources. A point-source is defined to emanate audio from one specific point, and thus it does not have any extent. In order to render an audio source with an extent, different audio rendering methods have been developed.

One of such audio rendering methods is to create multiple duplicates of a mono audio object at positions around the mono object's position. This creates the perception of a spatially homogeneous object with a certain size. This concept is used, for example, in the “object spread” and “object divergence” features of the MPEG-H 3D Audio standard [1] and [2], and in the “object divergence” feature of the EBU Audio Definition Model (ADM) standard [4]. This idea using a mono audio object (i.e., source) has been developed further in “Efficient HRTF-based Spatial Audio for Area and Volumetric Sources” [7], where the area-volumetric geometry of the audio object is projected onto a sphere around the listener and the audio is rendered to the listener using a pair of head-related (HR) filters that is evaluated as the integral of all the HR filters covering the geometric projection of the audio object on the sphere. For a spherical volumetric source, this integral has an analytical solution, while for an arbitrary area-volumetric source geometry, this integral is evaluated by sampling the projected source surface on the sphere using what is called a Monte Carlo ray sampling.

Another of the audio rendering methods is to render a spatially diffuse component in addition to the mono audio object, which creates the perception of a somewhat diffuse audio object (in contrast to the original mono audio object which has no distinct pin-point location). This method (or concept) is used, for example, in the “object diffuseness” feature of the MPEG-H 3D Audio standard [3] and the EBU ADM “object diffuseness” feature [5].

Combinations of the above two methods are also known. For example, the EBU ADM “object extent” feature [6] combines the creation of multiple copies of a mono audio object with addition of diffuse components.

In many cases the extent of an audio element can be described well enough with a basic shape (e.g., a sphere or a box). But sometimes the extent (or shape) of the audio element is more complicated, and thus needs to be described in a more detailed form (e.g., with a mesh structure or a parametric description format).

Some audio elements are of the nature that the listener can move inside the audio elements and can hear a plausible audio representation inside the audio elements. For these audio elements, the extent of the audio elements acts as a spatial boundary that defines the edge between the interior and the exterior of the audio elements. Examples of such audio elements could be (i) a forest (with sound of birds, sound of wind in the trees), (ii) a crowd of people (the sound of people clapping hands or cheering), and (3) background sound of a city square (sounds of traffic, birds, and/or people walking).

When the listener moves within the spatial boundary of such audio element, the audio representation should be immersive and surround the listener. On the contrary, as the listener moves out of the spatial boundary, the audio should appear to come from the extent of the audio element.

Although such audio element could be represented as a multitude of individual point-sources, it is often more efficient to represent this audio element with a single compound audio signal. For the interior audio representation of such audio element, a listener-centric format in which the sound field around the listener is described, is suitable. Listener-centric formats include channel-based formats as 5.1, 7.1 and scene-based formats such as Ambisonics. Listener-centric formats are typically rendered using several speakers positioned around the listener.

However, when the listener's position is outside of the spatial boundary of the audio element, there is no well-defined way to render a listener-centric audio signal to the listener directly. In such case, a source-centric representation is more suitable since the sound source no longer surrounds the listener but should instead be rendered to be coming from a distance in a certain direction. A solution is to use listener-centric audio signal for the interior representation and derive a source-centric audio signal from that, which can then be rendered using source-centric techniques. This technique is described in International Patent Application Publication No. WO2020/144061 [8] and the term used for these special kind of audio elements is spatially-bounded audio elements with interior and exterior representations. Further techniques of rendering the exterior representation of such an audio element, where the extent can be an arbitrary shape, is described in International Patent Application Publication No. WO2021/180820 [9].

### SUMMARY

As explained above, there are methods for rendering a spatially-bounded audio element in case the interior representation of the audio element is given. There are, however, cases where the interior representation of the audio element is undefined (i.e., unknown) and only the exterior representation of the audio element is given. For example, an audio element representing the sound of a forest with wind and birds in trees may be provided only with a stereo signal which is meant to be used for the exterior rendering of the audio element.

A related problem arises when a stereo signal (representing the left and right parts of the audio element) is used for the exterior representation of an audio element. In such case if the listener is located at the side of the audio element, the depth information of the audio element needed for an adequate representation of the audio element is not described by the stereo signal. FIGS. 14(a) and 14(b) illustrate such problem—the problem in rendering the exterior representation to a listener position that is to the side of the audio element. In FIG. 14(a), the listener is in front of the audio element and the left and right audio signals can be used directly for the speakers SpL and SpR. In FIG. 14(b), however, the listener is positioned to the side of the audio element and the given left and right audio signals are now aligned along the direction of the observation vector. In order to render the expected spatial width of the audio element as being perceived at the listening position, signals representing the front and back of the audio element are needed.

Thus, there is a need for a method of rendering a spatially-bounded audio element in cases where only the exterior representation of the audio element is given (i.e., the interior representation of the audio element is not given) so that the listener can perceive a plausible audio representation from a listening position inside the extent of the audio element.

Accordingly, in one aspect there is provided a method for rendering an audio element. The method comprises obtaining an exterior representation of the audio element and based on the obtained exterior representation, generating an interior representation of the audio element.

In another aspect, there is provided a computer program comprising instructions which when executed by processing circuitry of a device, causes the device to perform the method described above.

In another aspect, there is provided a device. The device comprises processing circuitry and a memory. The memory contains instructions executable by the processing circuitry. The device is configured to perform the method described above.

In another aspect, there is provided a device. The device is configured to obtain an exterior representation of the audio element and based on the obtained exterior representation, generate an interior representation of the audio element.

Embodiments of this disclosure provide a method of deriving the interior representation of an audio element from the exterior representation of the audio element. The method provides a unified solution that is applicable for most kinds of spatially-bounded audio elements in cases where only the exterior representations of the audio elements are given. The same rendering principles can be used for audio elements in cases where the exterior representations of the audio elements are specified in different formats. The method for rendering the audio elements is highly efficient and can easily be adapted for the best trade-off of high-quality and low complexity. The method of synthesizing parts of the interior representation makes it possible to achieve good control over the process of generating missing spatial information.

### BRIEF DESCRIPTION OF THE DRAWINGS

The accompanying drawings, which are incorporated herein and form part of the specification, illustrate various embodiments.

FIG. 1 shows an example of a spatially-bounded audio element.

FIG. 2 illustrates the concept of an interior representation of an audio element.

FIG. 3(a) illustrates an exemplary exterior representation of an audio element.

FIG. 3(b) illustrates an exemplary interior representation of an audio element.

FIG. 4 shows an exemplary setup of virtual loudspeakers.

FIG. 5 illustrates a method of rendering an exterior representation of an audio element according to an embodiment.

FIG. 6 illustrates a method of rendering an exterior representation of an audio element according to an embodiment.

FIG. 7 illustrates a rendering setup according to an embodiment.

FIGS. 8A and 8B show an XR system according to an embodiment.

FIG. 9 shows an audio renderer according to an embodiment.

FIG. 10(a) shows a signal modifier according to an embodiment.

FIG. 10(b) shows a deriver according to an embodiment.

FIG. 11 shows a process of rendering an audio element according to an embodiment.

FIG. 12 shows an apparatus for implementing an audio renderer according to an embodiment.

FIG. 13 illustrates how different elevation layers of an interior representation can be used in case the spatial information in different elevation angles needs be generated.

FIGS. 14(a) and 14(b) illustrate a problem in rendering the exterior representation to a listener position that is to the side of the audio element.

### DETAILED DESCRIPTION

### 1. Interior and Exterior Representations

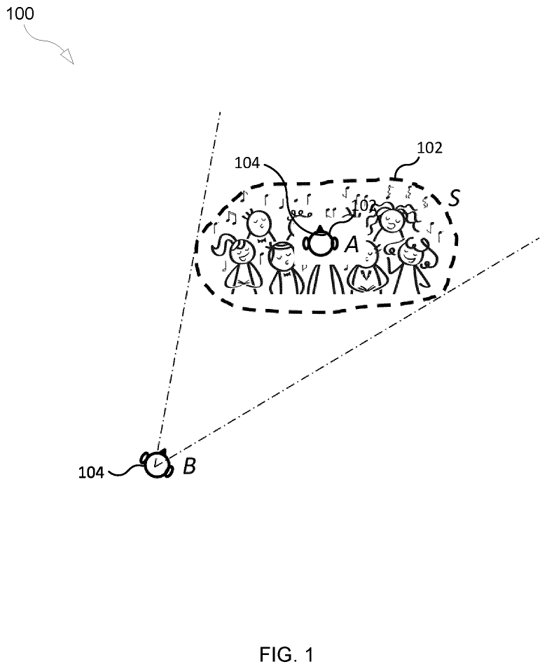

FIG. 1 shows an example of a spatially-bounded audio element 102 in an XR environment 100. The audio element 102 represents a choir where the group of singing people is located within a volume S which is defined as the spatial boundary of the audio element 102.

When a listener 104 of the audio element 102 is positioned at the listening position A inside the boundary S, the listener 104 is virtually surrounded by the choir, and thus a corresponding surrounding listening experience should be provided to the listener 104. In this case, a listener-centric audio format may be suitable for representing the audio element 102 since the listener-centric format is designed to present audio that surrounds the listener 104. The representation of the audio element 102 in the listener-centric format may be an interior representation of the audio element 102.

Interior representation of an audio element is a representation that can be used to produce an audio experience for a listener in which the listener will have the perception of being within the boundary of the audio element. Data used for the interior representation may comprise one or more interior representation audio signals (herein after, “interior audio signals”) that may be used to generate audio for the audio element.

On the other hand, when the listener 104 is positioned at the listening position B that is outside the boundary S, the listener 104 may expect to hear audio of the audio element 102 as if the audio is emanating from the volume (defined by the boundary S) of the audio element 102. The perceived angle, distance, size, and shape of the audio element 102 should correspond to the defined boundary S as perceived by the listener 104 at the position B. In this case, a source-centric audio format may be more suitable than the listener-centric audio format since the listener 104 should no longer be surrounded by the choir. The representation of the audio element in the source-centric format may be an exterior representation of the audio element 102.

Exterior representation of an audio element is a representation that can be used to produce an audio experience for a listener in which the listener will have the perception of being outside the boundary of the audio element. Exterior representation of an audio element may comprise one or more exterior representation audio signals (herein after, “exterior audio signals”) that may be used to generate audio for the audio element.

The listener 104 at the position B may also expect to obtain some spatial information from the audio element 102 (by hearing the audio from the audio element 102) such that the listener 104 can acoustically perceive that the choir is made up of many individual voices rather than just one diffuse audio source. In such case, the audio element 102 may correspond to a spatially heterogenous audio element. By using a multi-channel format for the exterior representation of the audio element 102, the listener 104 can be provided with a convincing spatial experience even at the listening positions outside of the boundary S. The concept of a spatially heterogenous audio element and the method of rendering the spatially heterogeneous audio element are described in International Patent Application Publication No. WO2020/144062 [10], which is hereby incorporated by reference.

In order to provide a realistic listening experience, both of the exterior and interior representations of an audio element may be needed. For example, the listener 104 may change the listener's position from the exterior listening position B to the interior listening position A. At this interior listening position A, the expected audio experience will be different. Accordingly, in some embodiments of this disclosure, an interior representation of an audio element is derived using an exterior representation of the audio element. Also, by using the derived interior representation, both the interior and exterior representations may be rendered.

The concept of exterior and interior representations of a spatially-bounded audio element and exemplary methods of deriving an exterior representation of an audio element based on an interior representation of the audio element are described in International Patent Application Publication No. WO2020/144061 [8], which is hereby incorporated by reference.

### 2. Deriving an Interior Representation

A spatially heterogeneous audio element may be defined with a set of audio signals that are meant to represent the spatial information of the audio element in a certain dimension. For example, the two channels of a stereo recording may be used to represent the audio element in the left-to-right dimension. With multi-channel recordings, the audio element may be represented in other dimensions. For example, a 4-channel recording may be used such that the four channels represent the top-left, top-right, bottom-left, and bottom-right of the audio element as perceived at a certain listening location.

Even though the above recordings are examples of multi-channel recordings, they are still a source-centric representation since they describe a sound source (i.e., an audio element) that is at some distance from the listener rather than a sound source surrounding the listener. Thus, the above recordings may not be suitable for an interior representation of the audio element. Accordingly, it is desirable to derive an interior representation of an audio element from an exterior representation of the audio element such that the audio element can be rendered in a listener-centric representation.

The exterior representation of the audio element, however, may not be able to represent the spatial information of the audio element in all dimensions. For example, when the listening position is within the boundary of the audio element, it is desirable to render the audio element in the depth dimension in a plausible way. For an audio element of which the exterior representation is based on a stereo recording, however, the depth information is not defined. Therefore, to provide spatial information for the depth dimension, new signals need to be generated. Since the real spatial information is not known, the generation of the missing information needs to be done using some general assumptions about the audio element.

### 2.1 Format Selection for Derived Interior Representation

The interior representation of an audio element can be based on different listener-centric audio formats. Examples of such listener-centric audio formats are Ambisonics and any one out of a large variety of channel-based formats such as quadraphonic, cubic octophonic, 5.1, 7.1, 22.2, a VBAP format, or a DirAC format. In those listener-centric audio formats, a number of audio channels are used to describe the spatial sound field inside the boundary of the audio element.

Some of the listener-centric audio formats describe the spatial information of the audio element in all directions with respect to the listening position inside the boundary of the audio element whereas others (e.g., 5.1 and 7.1) only describe the spatial information of the audio element in the horizontal plane.

For some audio elements, the spatial information of the audio element in the vertical plane is not as important as the spatial information of the audio element in the horizontal plane. Also, the human auditory system is less sensitive to spatial audio information in the vertical plane as compared to spatial information in the horizontal plane due to how the spatial cues (e.g., ITD and ILD) work. Therefore, sometimes it may be enough to describe the spatial information of an audio element in the horizontal plane only.

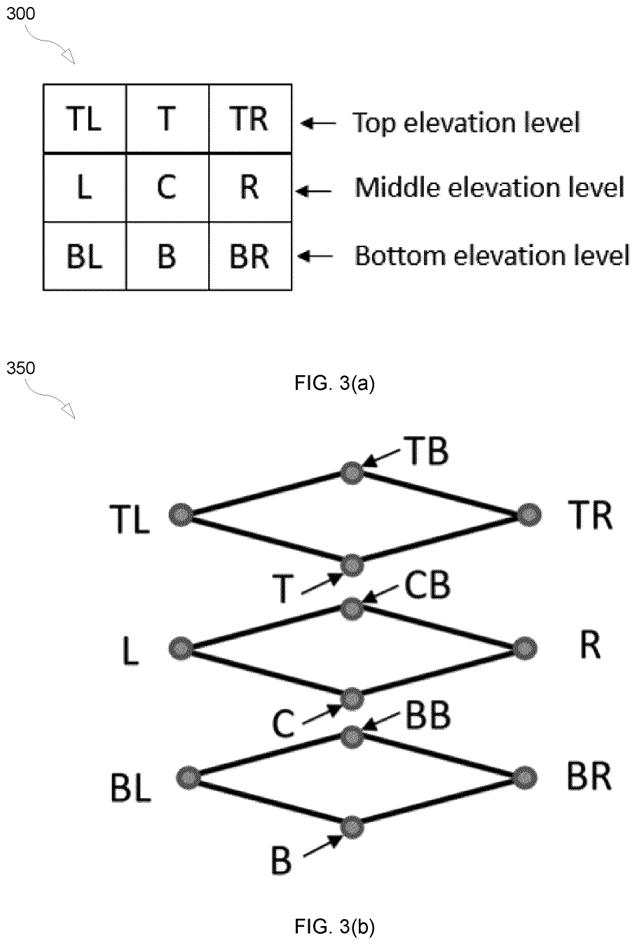

The format of an interior representation of an audio element (e.g., the types and/or the number of audio signals used for the interior representation) may be selected based on signals available in a given exterior representation of the audio element. For example, if the given exterior representation of the audio element is based on a stereo recording of which the two channels represent the audio element in the left-to-right dimension, the interior representation format (e.g., a quadraphonic format) that only describes the horizontal plane may be selected. On the other hand, if the exterior representation is based on a multi-channel format (e.g., see FIG. 3(a)) in which both horizontal and vertical spatial information is described, the interior representation format that describes the audio element in both dimensions may be selected. If the exterior representation is given in a multi-channel format where signals represent top-left, top, top-right, left, center, right, bottom-left, bottom, bottom-right of an audio element, or a subset of these, a multi layered quadraphonic format may be used. In such case, all of the given audio signals may be directly reused for the interior representation and only the audio signals representing the back of each elevation layer may need to be generated. This is illustrated in FIGS. 3(a) and 3(b).

Alternatively or additionally, other factor(s) may be taken into consideration when selecting the format of the interior representation. For example, if the complexity of audio rendering needs to be minimized, the interior representation format with less channels may be selected. In some cases, some spatial information in the exterior representation may be neglected in the interior representation in order to minimize the rendering complexity. For example, even when the exterior representation is based on a multi-channel format in which an audio element can be represented in a vertical dimension, a simple horizontal-only quadraphonic format may be used as the format of the interior representation.

### 2.2 Generating Signals for Interior Representation

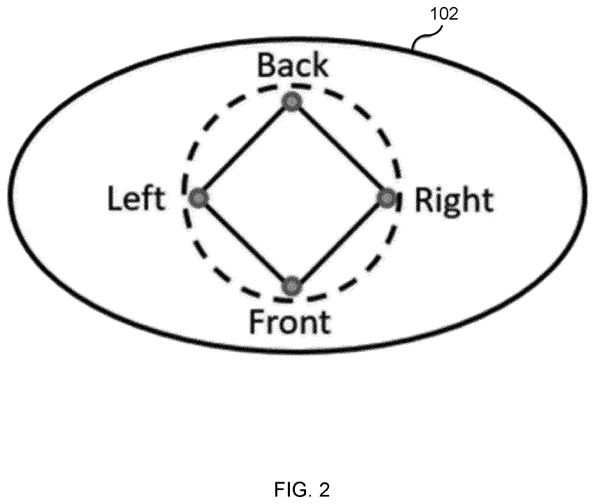

FIG. 2 illustrates an exemplary interior representation of the audio element 102. The interior representation is based on a quadraphonic audio format. For the interior representation, four audio channels are used to represent the left, right, front, and back of the audio element 102. The exemplary interior representation only describes the spatial information of the audio element 102 in the horizontal plane.

If an exterior representation of the audio element 102 is known and the exterior representation is based on a stereo signal that represents the left and right of the audio element 102, the stereo signal including a left signal and a right signal (a.k.a., left and right exterior representation signals) can be reused as the signals representing the left and right of the audio element 102 (a.k.a., left and right interior representation signals) in the interior representation. However, because there are no signals representing the front and back of the audio element 102 in the given exterior representation, those signals (a.k.a., missing interior representation signals) need to be generated for the interior representation. Thus, in one embodiment of this disclosure, those signals are generated based on the signal(s) for the exterior representation (i.e., the stereo signal in the above example).

In this disclosure, the term “audio signal” may simply be referred as “signal” for simplification.

Referring back to FIG. 1, the signal representing the front of the audio element 104 in the interior representation (a.k.a., front interior representation signal) may be generated based on a combination (e.g., a sum or a weighted sum) of the left and right exterior representation signals. In one embodiment, the front interior representation signal is a mean of the left and right exterior representation signals.

The signal representing the back of the audio element 104 in the interior representation (a.k.a., back interior representation signal) may be generated in the same way. Then, however, the audio element 102 would have no spatial information in the front-back dimension since the front and back interior representation signals would be the same. In such case, the audio element 102 would behave more like a coherent source in the front-back dimension.

In order to provide some spatial information in the front-back dimension for the audio element 102 in the interior representation, the back interior representation signal may be generated as a decorrelated version of the front interior representation signal. In such case, because the front and back interior representation signals are decorrelated to some degree, the audio element 102 would behave more like a diffuse source in the front-back dimension.

In another embodiment, the front interior representation signal may be generated as a decorrelated version of a mix of the left and right exterior representation signals. In such case, the audio element 102 in the interior representation would sound more diffuse when the listener is positioned in front of the audio element 102. This may not be desirable, however, if the audio element 102 is intended to sound similar to the left and right exterior representation signals when the listener is in front of the audio element 102. On the other hand, using a decorrelated version of a mix of the left and right exterior representation signals may increase the width and/or diffuseness of the audio element 104 perceived by the listener. Such increase in the perceived width and/or diffuseness may be desirable for certain audio elements. In case the front interior representation signal is generated as a decorrelated version of a mix of the left and right exterior representation signals, the back interior representation signal may be generated as a mix of the left and right exterior representation signal, a decorrelated version of the front interior representation audio signal, or another decorrelated version of a mix of the left and right exterior representation signals.

There are many methods of producing a decorrelated signal—i.e., the decorrelated version of another signal where certain aspects of the signal are taken into account. For example, there may be special handling of transients, harmonic, and noise components of audio. The process of decorrelation is for creating a signal that shares high-level properties with the original signal (e.g., having the same timbre, magnitude spectrum, time envelope, etc.) but has no, or a very low, degree of correlation with the original signal (e.g., in the sense that the cross-correlation of the two signals is close to zero). Classic methods for implementing a decorrelator use one of a large variety of fixed or dynamic delay line structures (which may be configured to delay the original signal), while more advanced implementations may use optimized (e.g. FIR) filter structures. More general information on decorrelation can be found at: https://en.wikipedia.org/wiki/Decorrelation #. An example of more advanced implementation of a decorrelator can be found at: https://www.audiolabs-erlangen.de/resources/2018-DAFx-VND.

If the generated audio signal(s) (e.g., the back interior audio signal) have too much correlation with the other signal(s) (e.g., the front interior audio signal), the spatial information in the dimension that the generated audio signal(s) represent (e.g., the front-back dimension) will be limited and when rendering the audio element, the size of the extent may not be perceived as wide enough by the listener. The level of decorrelation needed may depend on the characteristics of the audio element. In some embodiments, the amount of correlation needs to be less than a threshold of 50% in order to be provide a perceptual width that corresponds with the extent of the audio element when rendering the audio element.

The process of generating audio signals in the interior representation, which are not defined in the exterior representation, needs to be based on certain assumptions of what is expected for a certain audio source. It is, however, possible to use certain aspects of the exterior audio signals themselves as guidance for these assumptions. For example, measuring the correlation between different signals in the exterior representation may give a good indication of what level of correlation signals generated for the interior representation should have with other interior representation audio signals that are reused from the exterior representation. Measuring the variance, diffuseness, presence of transients, etc. can be used in similar ways to help in generating the missing interior representation signals.

Alternatively or additionally, extra metadata can be provided to represent an audio element. The metadata may define the expected behavior of the audio element. One example of such metadata is the audio element's diffuseness in different dimensions-a value of how diffuse the audio element should appear in different dimensions (e.g., the right-left dimension, the up-down dimension, the front-back dimension, etc.). Another example of such metadata is the metadata that may specify a desired degree of correlation between one or more of the provided (known) exterior representation audio signals (a.k.a., exterior audio signals) and one or more of the interior representation audio signals (a.k.a., interior audio signals) to be generated. For example, the metadata may specify that the back interior audio signal to be derived should have a correlation of 0.6 with the provided left exterior audio signal and a correlation of 0.2 with the provided right exterior audio signal. In yet another example, the metadata may comprise an upmix matrix that fully specifies how the interior representation is to be derived from the exterior representation.

When an audio format for the interior representation is selected that only describes the spatial information of an audio element in the horizontal plane, the audio element will behave like a coherent source in the vertical dimension since the same audio signals will be used to describe different parts of the audio element in the vertical dimension. Thus, if a representation of the audio element in the vertical dimension (i.e., the height dimension) is important for the audio element, the audio format used for the interior representation can be expanded, e.g., to a six-channel format where the extra two channels may be used to represent the bottom and top of the audio element. These two extra channels may be generated in a similar way as the front and back interior representation signals are generated.

FIG. 3(a) illustrates an exemplary exterior representation 300 of an audio element. The exterior representation 300 is based on a 9-channel audio format in which nine different channels represent the audio element's top-left, top, top-right, left, center, right, bottom-left, bottom, and bottom-right respectively. More specifically, the nine channels may correspond to the nine audio signals associated with nine different portions of the audio element in a vertical planar representation.

In order to represent the audio element's detailed spatial information given by the exterior representation, the interior representation of the audio element may need to be based on a rich audio format. For example, the interior representation can be a three-tier quadraphonic format 350 as illustrated in FIG. 3(b). As shown in FIG. 3(b), in the three-tier quadraphonic format 350, each of three different elevation levels is represented by left, right, front, back signals. By using this format, all of the available signals for the exterior representation (i.e., the exterior signals for the audio element's top-left, top, top-right, left, center, right, bottom-left, bottom, and bottom-right) can be directly reused for the interior representation. In such case, for the interior representation, only the interior signals TB (top-back), CB (center-back), BB (bottom-back) representing the backside of the audio element at each level need to be generated. Reusing the exterior audio signals as the interior audio signals is especially beneficial if generating the interior audio signals is to be performed in real-time.

Alternatively, an Ambisonics representation may be used for the interior representation. While in principle this may be an Ambisonics representation of any order, including first order, preferably a representation of at least 2nd order is used in order to preserve the spatial resolution contained in the exterior representation. Ambisonics format signals (i.e., the interior audio signals in the Ambisonics format) may be generated by using the previously described three-tier audio format as an intermediate format and by rendering the individual interior audio signals as virtual sound sources in the Ambisonics domain.

In some embodiments, the interior audio signals may be generated as a pre-processing step before a real-time rendering begins. There are some cases where this is not possible. For example, if the audio signals representing the audio element are not available before the rendering starts. This could be the case if the signals are generated in real-time, either because they are the result of a real-time capture or that the signals are generated by a real-time process, such as in the case of procedural audio.

Also, the generation of the interior audio signals may not be performed as the pre-processing step before the real-time rendering begins when the generation of the interior audio signals that are not defined in the exterior representation depends on parameters that are not available before the rendering begins. For example, if the generation of the interior representation depends on the momentary CPU load of an audio rendering device in such a way that a simpler interior representation is used when the CPU load needs to be limited, the generation of the interior audio signal may not be performed before the rendering begins. Another example is the case where the generation of the interior representation depends on the relative position of the audio element with respect to the listening position, e.g., in a way that a simpler interior representation is selected when the audio element is far away from the listening position.

### 3. Rendering Interior Representation Using Interior Representation

According to some embodiments, the methods for rendering an interior representation may depend on the kind of audio format that is selected for the interior representation.

### 3.1 Channel-Based Audio Formats

When an interior representation of an audio element is based on a channel-based audio format, one way to render the interior representation is to represent each channel of the interior representation with a virtual loudspeaker placed at an angle relative to the listener. The angle may correspond to the direction that each channel represents with respect to the front vector of the audio element.

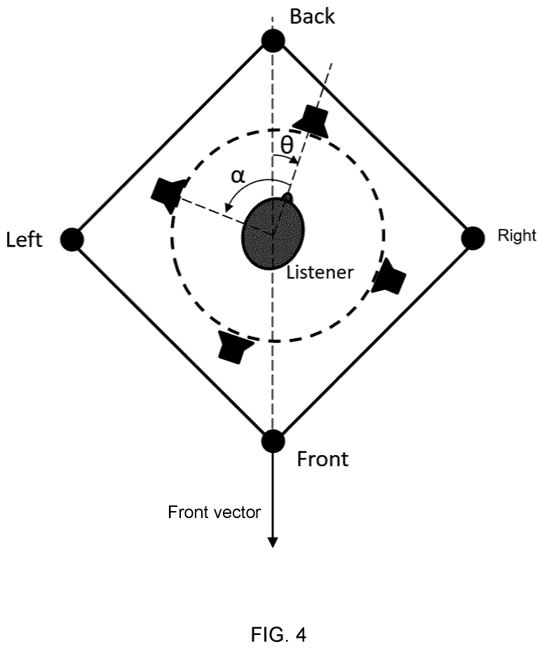

For example, a front interior audio signal may be rendered to come from a direction that is aligned with the front vector of the audio element (shown in FIG. 4), and a left interior audio signal may be rendered to come from a direction that is at a 90-degree angle with respect the front vector. This rendering largely corresponds to a virtual listening room where the listener is surrounded by the speaker setup and there is a direct and exclusive mapping between the interior audio signals and the virtual loudspeakers. In this case, the audio rendering does not depend on the head rotation of the listener.

In an alternative embodiment, the setup of virtual loudspeakers is decoupled from the orientation of the audio element and instead depends on some other reference direction, such as the head rotation of the listener. FIG. 4 shows a setup of virtual loudspeakers that can be used to render the horizontal plane of the interior representation. In this case the signals to each virtual loudspeaker can be derived from a virtual microphone placed in the center of the interior representation at an angle that corresponds to the angle of the virtual loudspeaker. For example, in FIG. 4, the signal going to the left virtual loudspeaker may be derived using a virtual microphone that is pointing in the direction of the virtual loudspeaker. In this case this virtual microphone would capture a mix of mostly the left and back signals. In this case, since the virtual loudspeakers of the rendering setup are not aligned with the directions of the audio element, the signals of the interior representation (i.e., the interior audio signals) cannot be directly used as input audio signals for the virtual loudspeakers. Instead, the input audio signal for each virtual loudspeaker can be derived with directional mixing of the interior audio signals.

The audio output associated with the directional mixing may correspond to a virtual microphone that is angled in a way that it captures audio in a certain direction of the interior representation. FIG. 4 shows an example of how the signal for the left virtual loudspeaker can be derived. In this example, the direction in which audio should be captured is 90 degrees to the left. Thus, the virtual microphone is directed in this direction in relation to the observation vector. The signal, M1, captured by this virtual microphone can, in one embodiment, be derived as

$${M}_{1} = max ( 0 , cos ( θ + α ) ) * F + max ( 0 , cos ( θ + α - \frac{π}{2} ) ) * L + max ( 0 , cos ( θ + α - π ) ) * B + max ( 0 , cos ( θ + α - \frac{3 π}{2} ) ) * R , \qquad \underline{Equation 1}$$

where θ is the angle between the listener's head direction and the front vector of the audio element, and a is the angle of the virtual microphone in relation to the listener's head direction. In this example, the interior representation only describes the spatial information of the audio element in the horizontal plane, and thus angles can be projected onto the horizontal plane.

As shown in Equation 1 above, an audio signal may be generated based on a combination of at least two interior audio signals. More specifically, the audio signal may be generated based on a weighted sum of at least two interior audio signals. In some embodiments, the weights used for the weighted sum may be determined based on a listener's orientation (e.g., obtained by one or more sensors). However, in other embodiments, the weights may be determined based on some other reference orientation, such as an orientation of the audio element (for example, in the above described embodiment where the audio rendering does not depend on the head rotation of the listener).

To represent the spatial information in the elevation dimension, it is needed to use an audio format for the interior representation that has signals representing the audio element in the up-down dimension. For example, the three-layer quadraphonic audio format as shown in FIGS. 3(a) and 3(b) may be used. In this case, the vertical angle of each virtual microphone may also be taken into account. This vertical angle may be used for making a directional mix of the elevation layers, where the signal of each layer is calculated using the horizontal directional mixing described above.

The signal of a microphone with an elevation angle Φ can then be calculated as M=max(0, sin(φ))*S_{TOP}+cos(φ)*S_{MID}+max(0, sin ((−φ))*S_{BOT}, where S_{TOP}, S_{MID} and S_{BOT} are the signals from each elevation layer, that were calculated using the horizontal directional mixing.

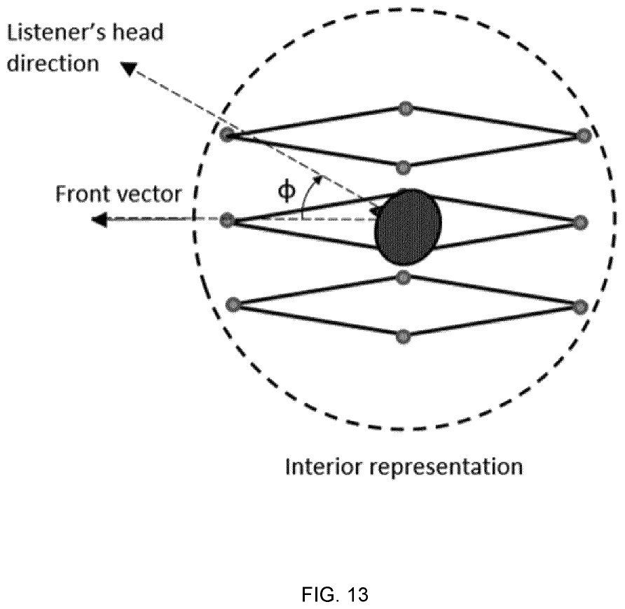

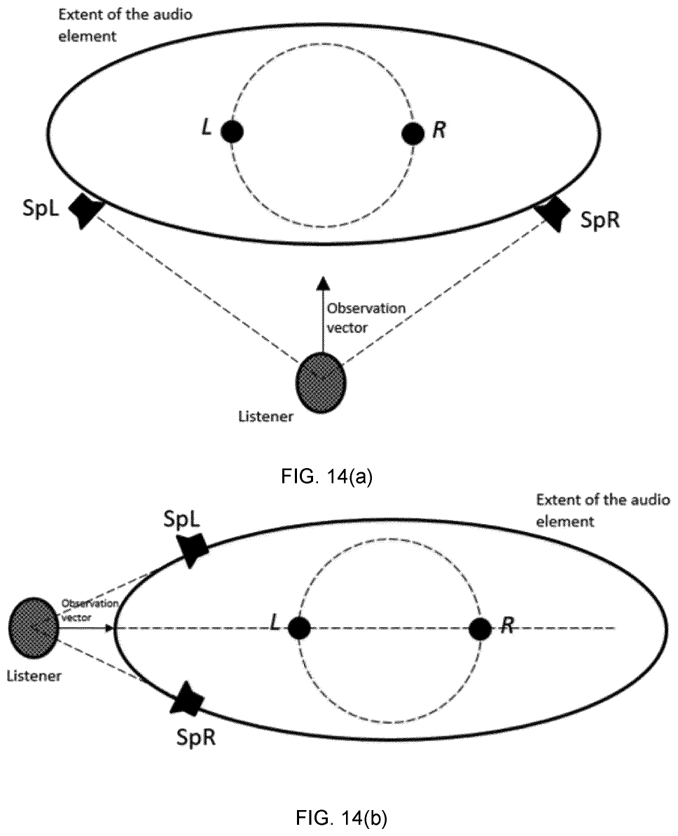

FIG. 13 shows how different elevation layers of an interior representation can be used when the spatial information in different elevation angles needs to be generated. In FIG. 13, the listener's head is directed upwards at an angle Φ. To generate the audio signal for a virtual loudspeaker representing the head direction of the listener, a directional mixing of the signals from the three layers can be used. Here, the directional mix would consist of mix of the upper and middle elevation layers.

### 3.2 Ambisonics

For rendering an interior representation based on an Ambisonics format, any of the available standard methods for rendering ambisonics can be used, such as those based on the use of a number of virtual loudspeakers or those that render the spherical harmonics directly using an HRTF set that has been converted to the spherical harmonics domain.

### 4. Deriving an Exterior Representation Using an Interior Representation

In addition to being used for rendering an extended audio element (that only has a provided exterior representation) to a listener positioned inside the audio element, the derived interior representation may also be used advantageously to enable an improved rendering at listening positions outside the audio element. Typically, the provided exterior representation (e.g. a stereo signal) represents the audio element for one specific listening position (“reference position”), for example, a center position in front of the audio element, and may not be directly suitable to render the audio element for other exterior listening positions, for example, to the side or back of the audio element. The derived interior representation may be used to provide a very flexible rendering mechanism that provides a listener a full 6DoF experience in exploring the sound around an extended audio element.

More specifically, even when the exterior representation is given, in some situations, it may be beneficial to first derive an interior representation from the given exterior representation and then to derive a new exterior representation from the derived interior representation. The reason is that the given exterior representation typically does not describe the spatial character in all dimensions of the audio element. Instead the given exterior representation typically only describes the audio element as heard from the front of the audio element. If the listener is situated to the side, above or below the audio element, similar to rendering the interior representation, the representation of the audio element in the depth dimension that is not defined may be needed.

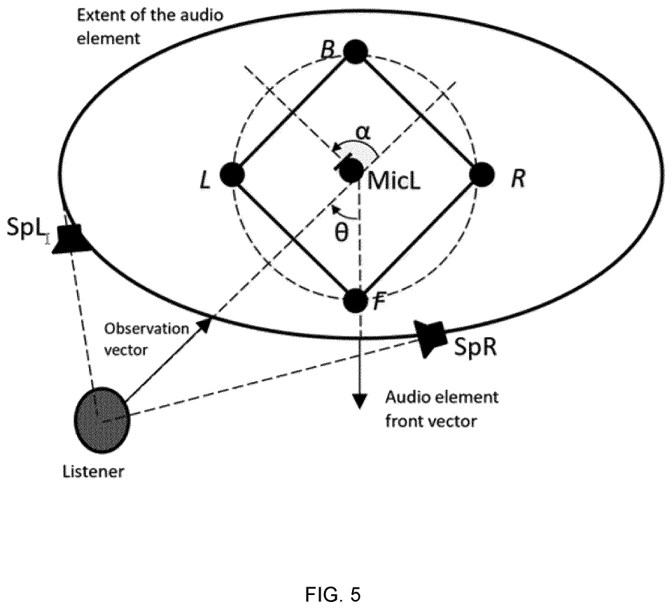

FIG. 5 illustrates an exemplary method of rendering an exterior representation of an audio element based on an interior representation of the audio element. Here, two virtual loudspeakers SpL and SpR are used to represent the audio element. In this example, the interior representation of the audio element is based on interior audio signals F, B, L, and R.

In FIG. 5, the observation vector between the listener and the spatial extent of the audio element is used as a basis for determining the orientation (i.e., the angle) of a virtual microphone MicL which captures audio signals for the virtual loudspeakers. The audio signal for the virtual loudspeaker SpL (representing the left side of the audio element 602 as acoustically perceived at the listener's position) may be derived from the interior representation (e.g., using the equation 1 above).

Here, with respect to the equation 1, 0 is the angle between the observation vector and the front vector of the audio element and a (90 degree in FIG. 5) is the orientation of the microphone MicL with respect to the observation vector. In FIG. 5, the virtual microphone is oriented in a direction between the directions represented by the interior audio signals L and B, and thus may capture a mixture of the two interior audio signals L and B.

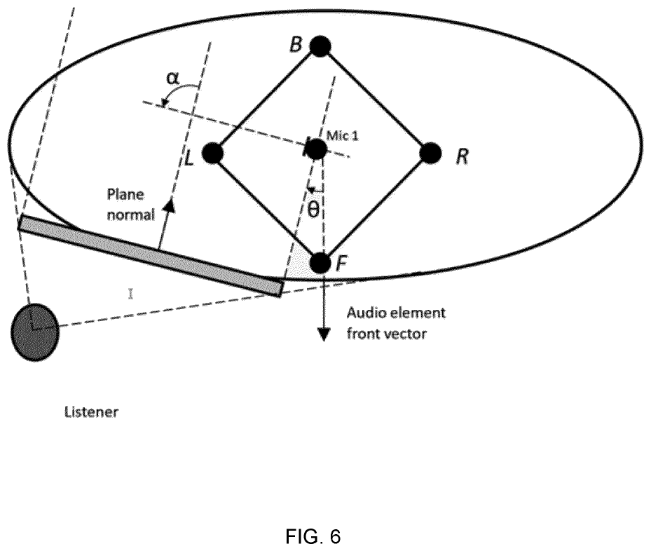

FIG. 6 illustrates another exemplary method of rendering an exterior representation of an audio element using an interior representation. In FIG. 6, a simplified extent of the audio element in the form of a plane is used to represent the spatial extent of the audio element acoustically perceived at the listening position. In this example, the angle used for deriving the exterior audio signal representing the left part of the extent of the audio element is based on the normal vector of the plane, instead of the observation vector.

The angle θ is the angle between the normal vector of the plane and the front vector of the audio element. The angle θ should be seen as representing the perspective that should be represented by the virtual loudspeakers of the exterior rendering. The angle θ may be related to the observation vector but does not always directly follow it.

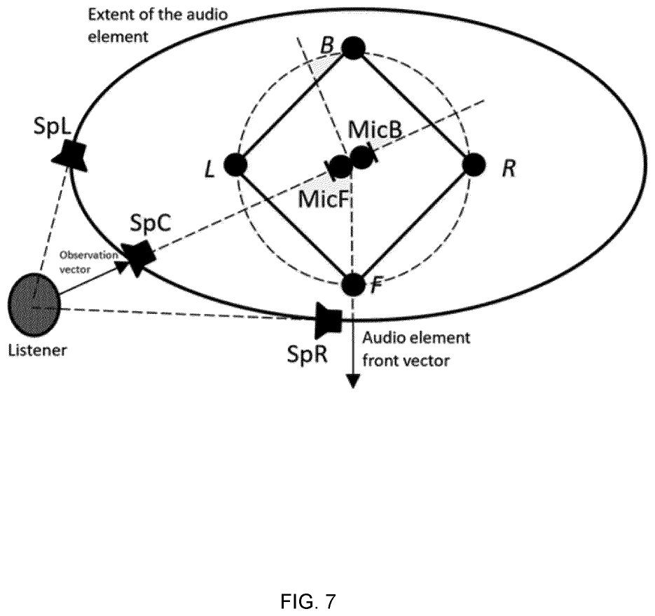

FIG. 7 shows an example of a rendering setup for an exterior representation. Three virtual speakers—SpL, SpC, and SpR—are used in the setup shown in FIG. 7. The audio signal provided to the speaker SpC may represent the audio coming from the center of an audio element. The audio coming from the center may include audio from the front and back of the audio element acoustically perceived at the listening position.

In this case a downmix can be created using the two microphones MicF and MicB. Also, since the frontal part of the audio element is closer to the listener position, an extra distance gain factor can be calculated and used. The extra distance gain factor may control the mix of the two microphone signals so that the signal from MicF is louder than the signal from MicB.

In some embodiments, only those components of the interior representation that are audible directly from the listener's current position may be included in the downmix. For example, if the listener is right in front of the audio element, only the left, right, and front audio components of the interior representation may be included in the downmix, and not the back audio component (which represents the back side of the audio element from which no sound may reach the listener directly.). Essentially, this implies that the extent of the audio element is an acoustically opaque surface from which no direct sound energy reaches the listener from the part(s) of the audio element that are acoustically occluded from the listener at the listener's position. In further embodiments, the contribution of the different components of the interior representation to the downmix can be controlled by specifying an “acoustic opacity factor” (in analogy of the opacity property in optics) for the audio element (for example, by including the acoustic opacity factor in metadata that accompanies the audio element or by setting a switch in the renderer and configuring the switch to operate based on the acoustic opacity factor). In such embodiments, when the acoustic opacity factor is 0, the audio element is acoustically “transparent” and all elements of the interior representation contribute equally to the downmix (aside from the possible distance gain as described above (e.g., see paragraph [0097])). On the contrary, when the acoustic opacity factor is 1, the audio element is acoustically fully opaque and thus only the components of the interior representation that reach the listener directly, i.e., without passing through the audio element, would be included in the downmix.

### 5. Mapping Channel-Based Signals to an Interior Representation

Channel-based audio signals of one format may be mapped to an interior representation using either the same format or a different format such as Ambisonics or some other channel-based formats, using any of the many corresponding mapping methods known to the skilled person.

### 6. Mapping Ambisonics Signals to a Channel-Based Interior Representation

An Ambisonics signal may also be mapped to an interior representation of an audio element based on a channel-based format using any of the many corresponding mapping methods known to the skilled person.

### 7. Example Use Case

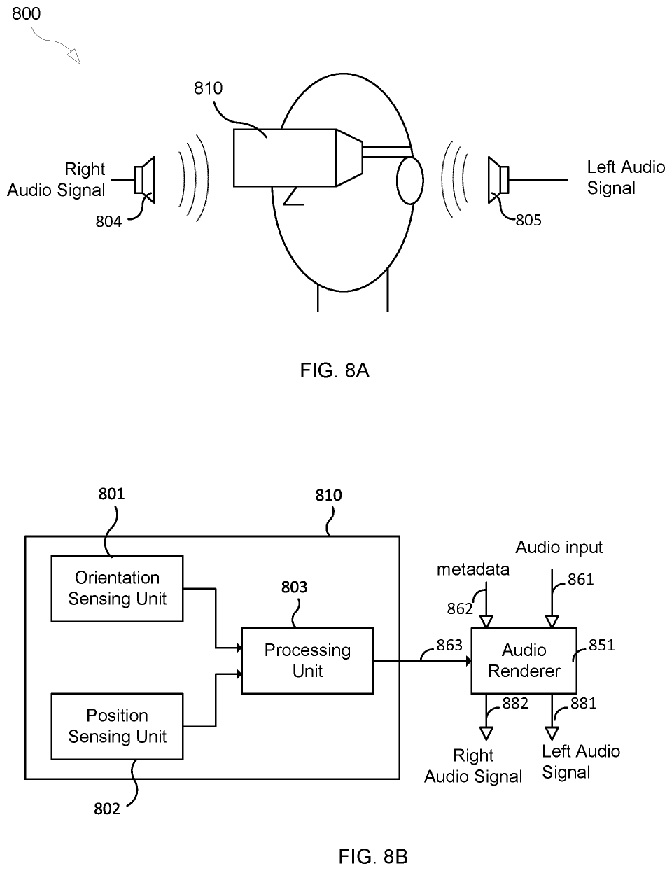

FIG. 8A illustrates an XR system 800 in which the embodiments may be applied. XR system 800 includes speakers 804 and 805 (which may be speakers of headphones worn by the listener) and a display device 810 that is configured to be worn by the listener. As shown in FIG. 8B, XR system 800 may comprise an orientation sensing unit 801, a position sensing unit 802, and a processing unit 803 coupled (directly or indirectly) to an audio render 851 for producing output audio signals (e.g., a left audio signal for a left speaker and a right audio signal for a right speaker as shown). Audio renderer 851 produces the output signals based on input audio signals, metadata regarding the XR scene the listener is experiencing, and information about the location and orientation of the listener. Audio renderer 851 may be a component of display device 810 or it may be remote from the listener (e.g., renderer 851 may be implemented in the “cloud”).

Orientation sensing unit 801 is configured to detect a change in the orientation of the listener and provides information regarding the detected change to processing unit 803. In some embodiments, processing unit 803 determines the absolute orientation (in relation to some coordinate system) given the detected change in orientation detected by orientation sensing unit 801. There could also be different systems for determination of orientation and position, e.g., a system using lighthouse trackers (LIDAR). In one embodiment, orientation sensing unit 801 may determine the absolute orientation (in relation to some coordinate system) given the detected change in orientation. In this case the processing unit 803 may simply multiplex the absolute orientation data from orientation sensing unit 801 and positional data from position sensing unit 802. In some embodiments, orientation sensing unit 801 may comprise one or more accelerometers and/or one or more gyroscopes.

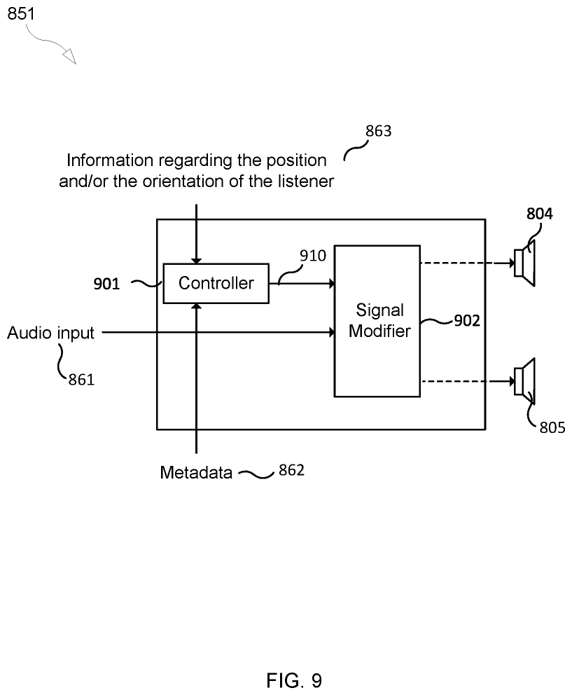

FIG. 9 shows an example implementation of audio renderer 851 for producing sound for the XR scene. Audio renderer 851 includes a controller 901 and a signal modifier 902 for modifying audio input 861 (e.g., a multi-channel audio signal) based on control information 910 from controller 901. Controller 901 may be configured to receive one or more parameters and to trigger modifier 902 to perform modifications on audio input 861 based on the received parameters (e.g., increasing or decreasing the volume level). The received parameters include (1) information 863 regarding the position and/or orientation of the listener (e.g., direction and distance to an audio element) and (2) metadata 862 regarding an audio element in the XR scene (e.g., audio element 102). Even though FIG. 9 shows that controller 901 and signal modifier 902 are two different entities, in some embodiments, they may be a single entity.

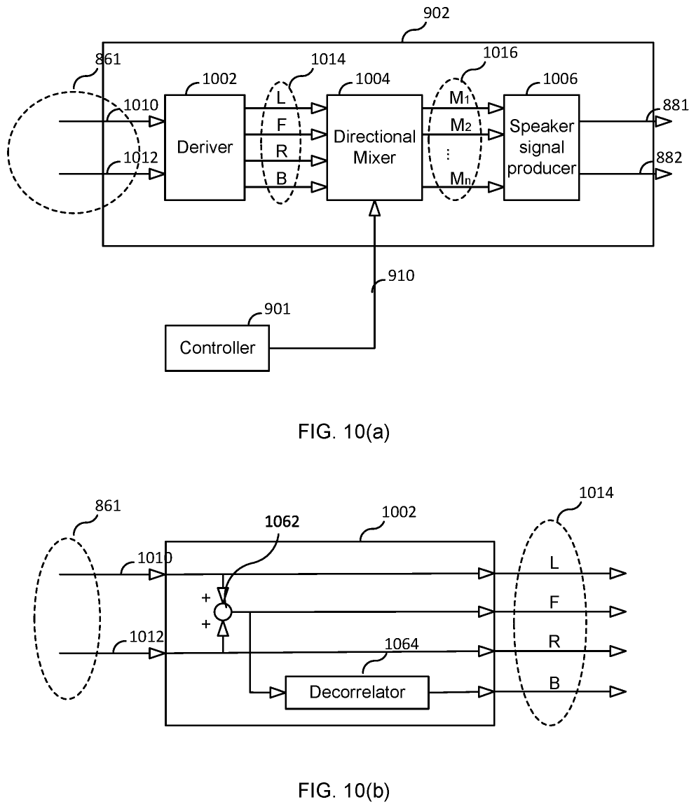

FIG. 10(a) shows an example implementation of signal modifier 902 according one embodiment. Signal modifier 902 includes a deriver 1002, a directional mixer 1004, and a speaker signal producer 1006.

Deriver 1002 receives audio input 861, which in this example includes a pair of exterior audio signals 1010 and 1012. Exterior audio signals 1010 and 1012 are for an exterior representation of an audio element. Using exterior audio signals 1010 and 1012, deriver 1002 derives an interior representation of the audio element from an exterior representation of the audio element. The deriving operation of deriver 1002 may be performed as a pre-processing step or in real-time. More specifically, deriver 1002 derives interior audio signals 1014 which are for the interior representation of the audio element. In FIG. 10, the interior audio signals 1014 comprises a left interior audio signal (L), a right interior audio signal (R), a front interior audio signal (F), and a back interior audio signal (B).

FIG. 10(b) shows an example of deriver 1002 according to an embodiment. As shown in FIG. 10(b), deriver 1002 may comprise a combiner 1062 and a decorrelator 1064. Combiner 1062 is configured to combine (or mix) the exterior audio signals 1010 and 1012, thereby generating a new interior audio signal (e.g., the front interior audio signal F). Decorrelator 1064 is configured to perform a decorrelation on a received audio signal. For example, in FIG. 10(b), decorrelator 1064 is configured to perform a decorrelation on the front interior audio signal F, thereby generating a back interior audio signal B. Detailed explanation about the combination (or mixing) and the decorrelation is provided in Section 2 of this disclosure above.

Directional mixer 1004 receives the interior audio signals 1014, and produces a set of n virtual speaker signals (M₁, M₂, . . . , Mₙ) (i.e., audio signals for virtual loudspeakers, representing a spatial extent of an audio element) based on the received interior audio signals 1014 and control information 910. In the example where audio element 102 is associated with three virtual speakers (SpL, SpC, and SpR), then n will equal 3 for the audio element and M₁ may correspond to SpL, M₂ may correspond to SpC, and M₃ may correspond to SpR. The control information 910 used by directional mixer 1004 to produce the virtual speaker signals may include, or may be based on, the positions of each virtual speaker relative to the audio element, and/or the position and/or orientation of the listener (e.g., direction and distance to an audio element). Detailed information about directional mixing is described in Section 3.1 of this disclosure above. For example, the virtual speaker signal M₁ may be generated using the equation 1 disclosed in Section 3.1 of this disclosure.

Using the virtual speaker signals (M₁, M₂, . . . , Mₙ), speaker signal producer 1006 produces output signals (e.g., output signal 881 and output signal 882) for driving speakers (e.g., headphone speakers or other speakers). In one embodiment where the speakers are headphone speakers, speaker signal producer 1006 may perform conventional binaural rendering to produce the output signals. In embodiments where the speakers are not headphone speakers, speaker signal producer 1006 may perform conventional speaker panning to produce the output signals. The operations of directional mixer 1004 and speaker signal producer 1006 may be performed in real-time.

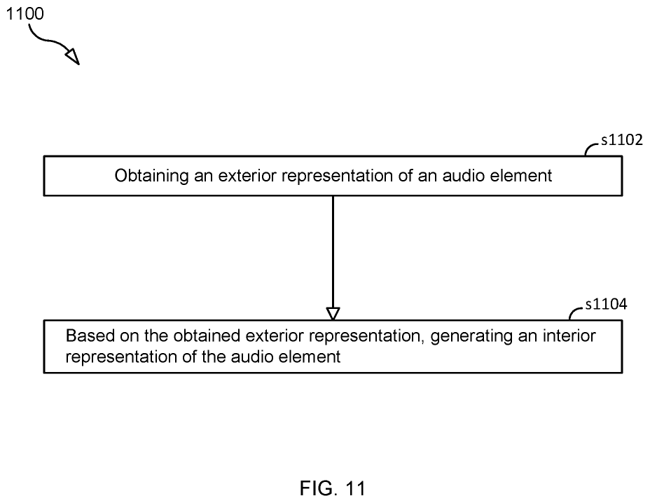

FIG. 11 shows a process 1100 for rendering an audio element. The process 1100 may begin with step s1102. Step s1102 comprises obtaining an exterior representation of the audio element. Step s1104 comprises, based on the obtained exterior representation, generating an interior representation of the audio element.

In some embodiments, the exterior representation of the audio element comprises one or more exterior audio signals for producing an audio experience in which a listener of the audio element has the perception of being outside a boundary of the audio element, and the interior representation of the audio element comprises one or more interior audio signals for producing an audio experience in which the listener has the perception of being inside the boundary of the audio element.

In some embodiments, the exterior representation of the audio element comprises an exterior audio signal, and the interior representation of the audio element comprises an interior audio signal, wherein the interior audio signal is not a component of the exterior representation.

In some embodiments, the exterior representation of the audio element comprises a first exterior audio signal and a second exterior audio signal, the interior representation of the audio element comprises a first interior audio signal and a second interior audio signal, and the first interior audio signal is generated using the first exterior audio signal and the second exterior audio signal.

In some embodiments, the first interior audio signal is generated based on a mean of the first and second exterior audio signals.

In some embodiments, the mean of the first and second exterior audio signals is a weighted mean of the first and second exterior audio signals.

In some embodiments, a degree of correlation between the first interior audio signal and the second interior audio signal is less than a threshold.

In some embodiments, the second interior audio signal is generated by performing a decorrelation on the first interior audio signal or a combined signal of the first and second exterior audio signals.

In some embodiments, the decorrelation comprises changing the phase of the first interior audio signal at one or more frequencies or changing the phase of the combined signal at one or more frequencies.

In some embodiments, the decorrelation comprises delaying the first interior audio signal or delaying the combined signal.

In some embodiments, the decorrelation is performed based on metadata associated with the audio element, and the metadata comprises diffuseness information indicating diffuseness of the audio element in one or more dimensions.

In some embodiments, the exterior representation of the audio element comprises an exterior audio signal, the interior representation of the audio element comprises an interior audio signal, and a degree of correlation between the exterior audio signal and the interior audio signal is less than a threshold.

In some embodiments, the interior representation of the audio element comprises at least two interior audio signals, and the method further comprises combining said at least two interior audio signals, thereby generating an audio output signal.

In some embodiments, the method further comprises obtaining a listener's orientation with respect to the audio element, wherein said at least two interior audio signals are combined based on the obtained listener's orientation.

In some embodiments, the method further comprises obtaining an orientation of the audio element, wherein said at least two interior audio signals are combined based on the obtained orientation of the audio element.

In some embodiments, the combination of said at least two interior audio signals is a weighted sum of said at least two interior audio signals.

In some embodiments, weights for the weighted sum are determined based on the obtained listener's orientation.

In some embodiments, weights for the weighted sum are determined based on the obtained orientation of the audio element.

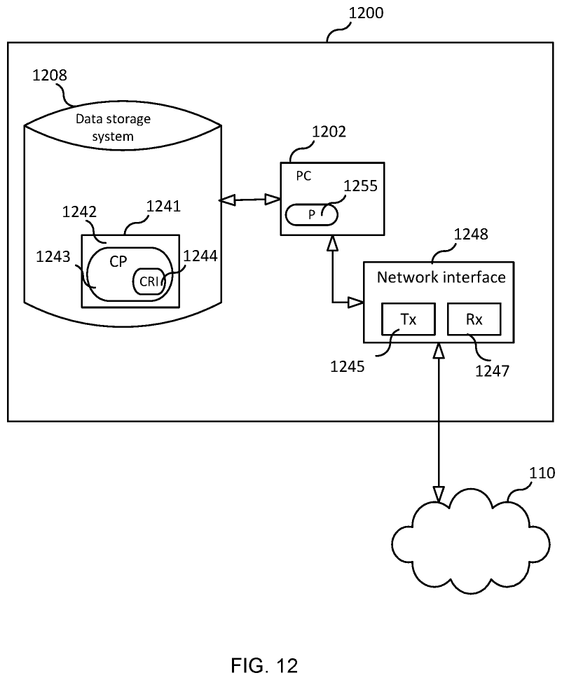

FIG. 12 is a block diagram of an apparatus 1200, according to some embodiments, for performing the methods disclosed herein (e.g., audio renderer 851 may be implemented using apparatus 1200). As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

While various embodiments are described herein (an in any appendix), it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCE LIST

[1] MPEG-H 3D Audio, Clause 8.4.4.7: “Spreading” [2]
[2] MPEG-H 3D Audio, Clause 18.1: “Element Metadata Preprocessing” [3]
[3] MPEG-H 3D Audio, Clause 18.11: “Diffuseness Rendering” [4]
[4] EBU ADM Renderer Tech 3388, Clause 7.3.6: “Divergence” [5]
[5] EBU ADM Renderer Tech 3388, Clause 7.4: “Decorrelation Filters” [6]
[6] EBU ADM Renderer Tech 3388, Clause 7.3.7: “Extent Panner” [7]
[7] “Efficient HRTF-based Spatial Audio for Area and Volumetric Sources”, IEEE Transactions on Visualization and Computer Graphics 22 (4): 1-1⋅January 2016
[8] PCT/EP2019/086876 (WO2020/144061)
[9] PCT/EP2021/056112 (WO2021/180820)
[10] PCT/EP2019/086877 (WO2020/144062)

1. A method for rendering an audio element, the method comprising:
obtaining an exterior representation of the audio element; and
based on the obtained exterior representation, generating an interior representation of the audio element.

2. The method of claim 1, wherein
the exterior representation of the audio element comprises one or more exterior audio signals for producing an audio experience in which a listener of the audio element has the perception of being outside a boundary of the audio element, and
the interior representation of the audio element comprises one or more interior audio signals for producing an audio experience in which the listener has the perception of being inside the boundary of the audio element.

3. The method of claim 1, wherein
the exterior representation of the audio element comprises an exterior audio signal, and
the interior representation of the audio element comprises an interior audio signal, wherein
the interior audio signal is not a component of the exterior representation.

4. The method of claim 1, wherein
the exterior representation of the audio element comprises a first exterior audio signal and a second exterior audio signal,
the interior representation of the audio element comprises a first interior audio signal and a second interior audio signal, and
the first interior audio signal is generated using the first exterior audio signal and the second exterior audio signal.

5. The method of claim 4, wherein the first interior audio signal is generated based on a mean of the first and second exterior audio signals.

6. The method of claim 5, wherein the mean of the first and second exterior audio signals is a weighted mean of the first and second exterior audio signals.

7. The method of claim 4, wherein a degree of correlation between the first interior audio signal and the second interior audio signal is less than a threshold.

8. The method of claim 4, wherein the second interior audio signal is generated by performing a decorrelation on the first interior audio signal or a combined signal of the first and second exterior audio signals.

9. The method of claim 8, wherein the decorrelation comprises changing the phase of the first interior audio signal at one or more frequencies or changing the phase of the combined signal at one or more frequencies.

10. The method of claim 8, wherein the decorrelation comprises delaying the first interior audio signal or delaying the combined signal.

11. The method of claim 8, wherein
the decorrelation is performed based on metadata associated with the audio element, and
the metadata comprises diffuseness information indicating diffuseness of the audio element in one or more dimensions.

12. The method of claim 1, wherein
the exterior representation of the audio element comprises an exterior audio signal,
the interior representation of the audio element comprises an interior audio signal, and
a degree of correlation between the exterior audio signal and the interior audio signal is less than a threshold.

13. The method of claim 1, wherein
the interior representation of the audio element comprises at least two interior audio signals, and
the method further comprises
combining said at least two interior audio signals, thereby generating an audio output signal.

14. The method of claim 13, further comprising obtaining a listener's orientation with respect to the audio element, wherein
said at least two interior audio signals are combined based on the obtained listener's orientation.

15. The method of claim 13, further comprising obtaining an orientation of the audio element, wherein
said at least two interior audio signals are combined based on the obtained orientation of the audio element.

16. The method of claim 13, wherein the combination of said at least two interior audio signals is a weighted sum of said at least two interior audio signals.

17. The method of claim 16, wherein weights for the weighted sum are determined based on the obtained listener's orientation.

18. The method of claim 16, wherein weights for the weighted sum are determined based on the obtained orientation of the audio element.

19-20. (canceled)

21. A device for rendering an audio element, the device comprising:
processing circuitry; and
a memory, the memory containing instructions executable by the processing circuitry, whereby the device is configured to perform;
obtain an exterior representation of the audio element; and
based on the obtained exterior representation, generate an interior representation of the audio element.

22-23. (canceled)

24. The device of claim 21, wherein
the exterior representation of the audio element comprises one or more exterior audio signals for producing an audio experience in which a listener of the audio element has the perception of being outside a boundary of the audio element, and
the interior representation of the audio element comprises one or more interior audio signals for producing an audio experience in which the listener has the perception of being inside the boundary of the audio element.
